(19) United States
(12) Patent Application Publication
(10) Pub. No.: US 2016/0009256 A1
(43) Pub. Date: Jan. 14, 2016

(54) VEHICLE WITH INTEGRAL TIRE JACKS

(71) Applicant: King Fahd University of Petroleum and Minerals, Dhahran (SA)

(72) Inventors: MEHMET DONDURUR, CROFTON, MD (US); AHMET Z. SAHIN, DHAHRAN (SA)

(21) Appl. No.: 14/860,691

(22) Filed: Sep. 21, 2015

Related U.S. Application Data
(63) Continuation-in-part of application No. 13/760,031, filed on Feb. 5, 2013.

(51) Int. Cl. B60S 9/12

(52) U.S. Cl. CPC B60S 9/12

(57) ABSTRACT

The vehicle with integral tire jacks is an automatic built-in system for lifting a vehicle in the event of a flat tire when the tire requires replacement. The system includes four jacks installed under the vehicle near each wheel. An air compressor activated and controlled by an internal control panel will provide pressure to the jacks, the control panel being provided with knobs and buttons enabling the control of a desired jack. Each jack is adapted for being integrally mounted beneath the automobile, adjacent at least one wheel thereof. The jack includes a housing and a piston extendable from the housing. The piston has opposed upper and lower ends and a foot attached to the lower end thereof.

### CROSS-REFERENCE TO RELATED APPLICATION

This application is a continuation-in-part of U.S. patent application Ser. No. 13/760,031, filed on Feb. 5, 2013.

### BACKGROUND OF THE INVENTION

1. Field of the Invention

The present invention relates to automobile jacks, and particularly to a vehicle with integral tire jacks.

2. Description of the Related Art

The most common use of automobile jacks is to elevate one side of a car or truck for removal and replacement of a flat tire. A portable, manually operable jack matched to the specific type of vehicle is often provided with new vehicles. The operator would normally remove the jack from its storage position and position the jack under the vehicle's frame. The operator would then manually crank the jack to free the flat tire from contact with the ground. Subsequently, the operator would remove the tire using tools, such as a lug wrench or spider wrench, and replace the tire in the same manner.

Occasionally, flat tires occur during inclement weather, causing difficulty in accessing and using a portable jack to raise a flat tire. Likewise, portable jacks may be lost and are not available for service. At other times, the jack may be stored in a trunk under luggage, requiring the trunk to be unloaded. A vehicle may have a flat lowering the vehicle to such a degree that a portable jack cannot be placed under the vehicle. During a general maintenance procedure, such as tire rotation, it is often time-consuming and difficult to sequentially raise the vehicle and remove a first tire, lower the vehicle, then raise another portion of the vehicle, remove a second tire and replace it with the first tire, and then repeat the process until all of the tires have been rotated. Other uses of jacks include accessing the underside of a vehicle for such things as oil changes, as well as body work, etc.

Thus, a vehicle with integral tire jacks solving the aforementioned problems is desired.

### SUMMARY OF THE INVENTION

The vehicle with integral tire jacks is a vehicle having a control panel and system that provides for lifting the vehicle for changing a tire or for any other reason requiring access to the underside of a vehicle. The integral tire jacks include at least four pneumatic jacks, each one associated with a vehicle wheel. The integral tire jacks also include a complete control system that provides a self-contained system for lifting the vehicle with ease and safety. Confirmation buttons located in the control panel turn from red to green prior to operating the lift. Also, the system may have a flat tire detector sensor that indicates that a tire is flat. Another confirmation sensor may be provided to detect the flat tire wheel bolt tightness and looseness prior to lifting. In addition, the controls may permit the user to start lifting by a first push on a control button, to stop lifting and hold the wheel in the elevated position by a second push on the control button, and to start lowering the vehicle by a third push on the control button. It is noted that such push button operation is similar to the operation of currently available garage door openers and the like.

The integral tire jacks provide safety features to enhance the usability of the system. First, a set of readable instructions, in the form of indicia, is provided for the user to reference and follow the proper procedures in use. In addition, the control system of the integral tire jacks provides a plurality of sensors for detecting vehicle parameters, and determines if the vehicle is ready to be lifted by the integral tire jacks. Also, an indicator provides a visual (and audio) annunciation to notify the user that the vehicle is ready to be lifted. In addition, another safety feature includes a manual brace associated with each jack for maintaining the stability of the jack, and to provide a solid member to support the vehicle in case the pneumatic jack fails.

At least one pneumatic jack is provided and is adapted for being integrally mounted beneath the automobile, adjacent at least one wheel thereof. The at least one pneumatic jack includes a housing and a piston extendable from the housing. The piston has opposed upper and lower ends, and a foot attached to the lower end thereof.

In an alternative embodiment, the housing has at least one first recess and at least one second recess defined in an inner surface thereof. The at least one first recess and the at least one second recess are diametrically opposed with respect to one another. First and second stop members are mounted to the upper end of the piston. Each of the first and second stop members is spring-tensioned and respectively aligned with the at least one first recess and the at least one second recess defined in the inner surface of the housing. When the piston is an extended state, each of the first and second stop members resiliently and releasably engages the at least one first recess and the at least one second recess, respectively, to releasably maintain and securely hold the piston in an extended state with respect to the housing.

In another alternative embodiment, the housing includes upper and lower portions that are telescopically joined to one another such that the lower portion telescopes from the upper portion. A first set of spring-biased stop members is mounted adjacent an upper end of the lower portion of the housing, such that when the lower portion is an extended state with respect to the upper portion of the housing, the first set of stop members releasably engages a lower annular wall of the upper portion to releasably maintain the lower portion in the extended state with respect to the upper portion of the housing. Similarly, a second set of spring-biased stop members is mounted adjacent the upper end of the piston, such that when the piston is in an extended state with respect to the lower portion of the housing, the second set of stop members releasably engages a lower annular wall of the lower portion to releasably maintain the piston in the extended state with respect to the lower portion of the housing.

Additionally, the at least one pneumatic jack may include at least one support bar having opposed fixed and free ends. The fixed end is pivotally mounted to the housing by a hinge or the like. When the piston extends from the housing, the at least one support bar pivots to extend between the housing and the foot, providing vertical support for the housing. As a further alternative, at least one first spring-biased stop member may be mounted to the housing adjacent the fixed end of the at least one support bar, such that when the at least one support bar extends between the housing and the foot, the at least one first stop member releasably prevents pivoting of the at least one support bar. Similarly, at least one second spring-biased stop member may be mounted adjacent the upper end of the piston, such that when the piston is in the extended state with respect to the housing, the at least one second stop member releasably engages a lower annular wall of the housing to releasably maintain the piston in the extended state with respect thereto.

These and other features of the present invention will become readily apparent upon further review of the following specification.

### BRIEF DESCRIPTION OF THE DRAWINGS

FIG. 1 is an environmental side view of a vehicle with integral tire jacks according to the present invention.

FIG. 2 is a partial side view of a vehicle with integral tire jacks according to the present invention.

FIG. 3 is a bottom view of a vehicle with integral tire jacks according to the present invention.

FIG. 4 is a front view of a control panel for a vehicle with integral tire jacks according to the present invention.

FIG. 5A is a diagrammatic partial side view in section of an alternative embodiment of the vehicle with integral tire jacks, shown with the piston retracted into the housing.

FIG. 5B is a diagrammatic partial side view in section of the vehicle with integral tire jacks of FIG. 5A, shown with the piston in an extended position.

FIG. 6 is a diagrammatic partial side view of another alternative embodiment of the vehicle with integral tire jacks, shown with a lower portion of the upper and lower housing sections broken away.

FIG. 7 is a diagrammatic partial side view of still another alternative embodiment of the vehicle with integral tire jacks, shown with a lower portion of the housing broken away.

Similar reference characters denote corresponding features consistently throughout the attached drawings.

### DETAILED DESCRIPTION OF THE PREFERRED EMBODIMENTS

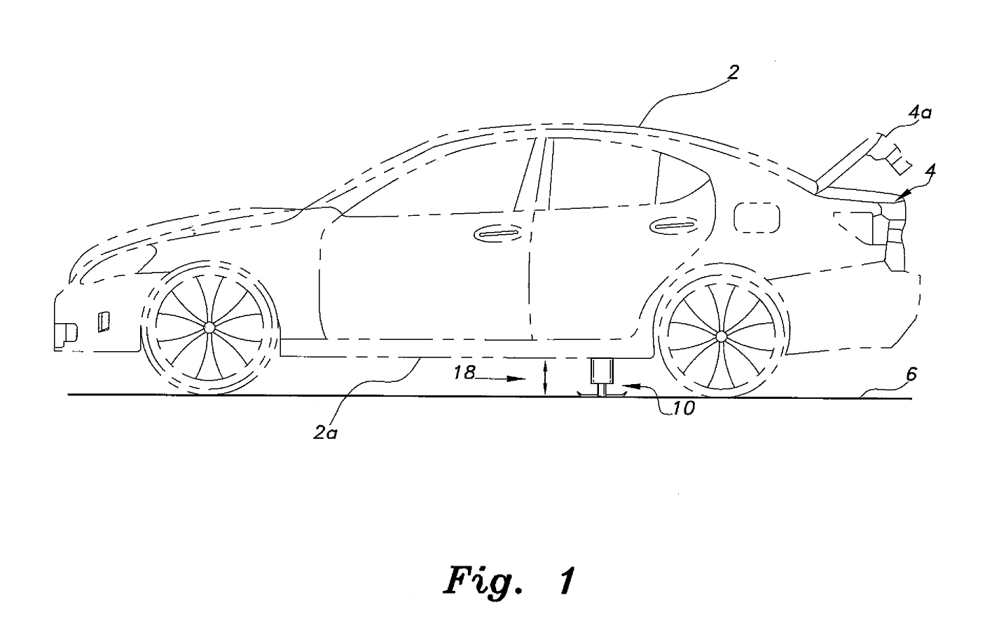

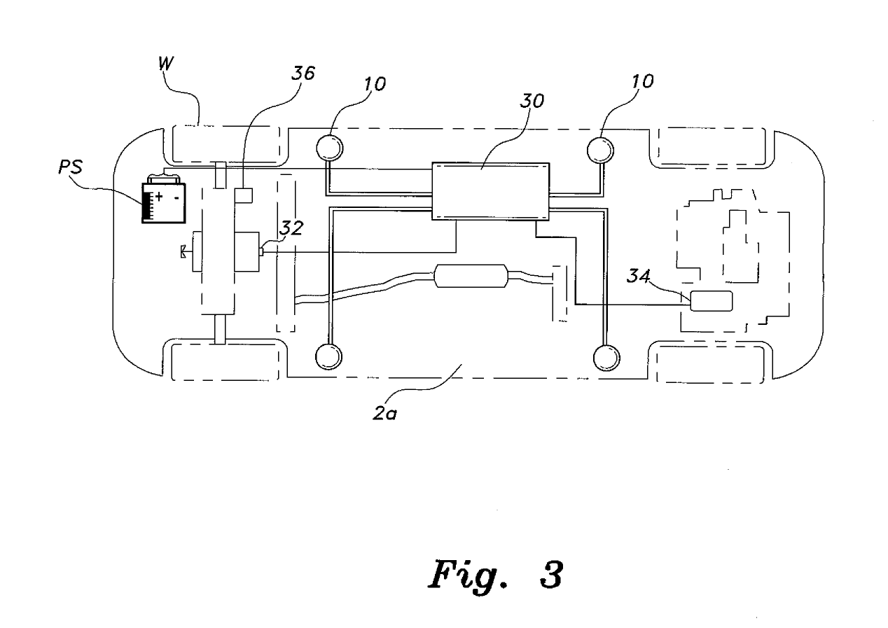

As seen in FIGS. 1 and 3, the vehicle with integral tire jacks for lifting a vehicle is a system that has a pneumatic jack 10 integrally mounted beneath a vehicle 2 near each one of the wheels. Thus, there are at least four units 10, each integrally attached to the underside 2a of a vehicle 2 near each wheel. Preferably, the units should be located between the wheels on each side of the vehicle 2. That is, the jack 10 near the rear wheel is located forward of the rear wheel, and the jack 10 associated with the front wheel is located rearward of the front wheel. The integral tire jacks 10 are extendable from the underside 2a of the vehicle 2 to raise the vehicle 2 above the ground or supporting surface 6 so that a wheel of the vehicle 2 is lifted off the ground or supporting surface 6 to a preferred distance. The lifting, and subsequent lowering, is along the directional arrows 18. The preferred distance to lift the vehicle 2 along the directional arrows 18 is on the order of two (2) inches of clearance of the wheel from the ground 6.

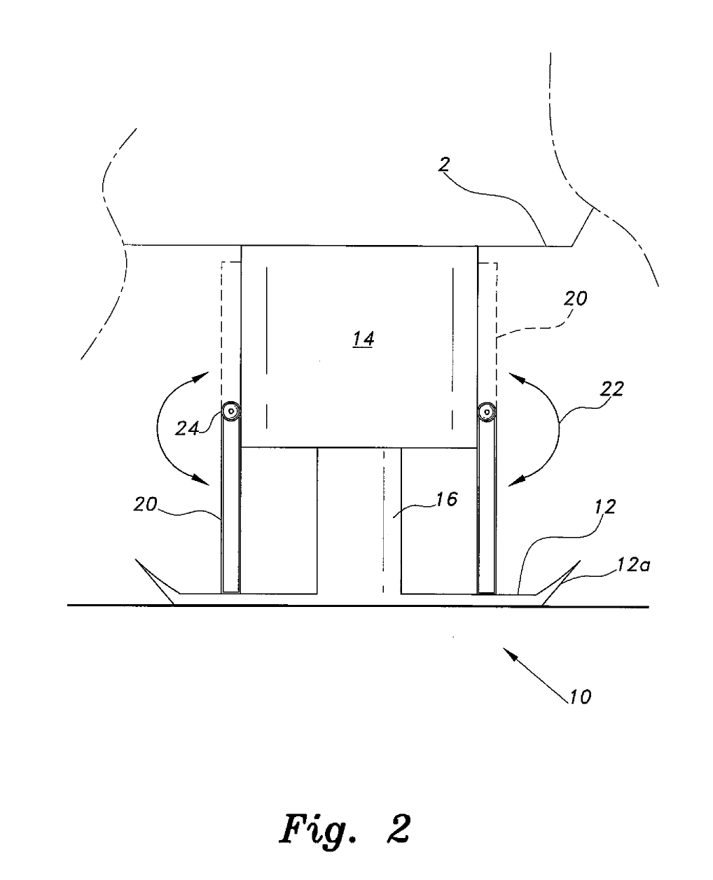

Referring to FIG. 2, each one of the pneumatic jacks 10 includes a housing 14. The housing 14 is also an outer cylinder of the jack 10. The jack 10 further includes a telescoping piston 16, which has a foot 12 for engagement with the surface 6. The foot 12 also has a housing seal 12a such that when the piston 16 of the jack 10 is in the retracted position, the housing seal 12a of the foot 12 closes the housing 14, preventing road debris from entering the cylinder housing 14 and collecting and/or causing the jack 10 to malfunction.

The foot 12 has an outer diameter greater than the housing 14, so that the seal 12a completely encloses the housing 14 when the piston 16 is in the retracted position. Additionally, the foot 12 is formed of a material having a high coefficient of friction (e.g., rubber) for increased frictional engagement with the ground or support surface 6.

As seen in FIG. 2, the jack 10 also has an additional safety feature, which is a support bar 20 pivotally attached via hinge member 24 to the housing 14. The support bars 20 are pivoted into position once the piston 16 has been extended and the foot 12 engages the ground surface 6. The support bars 20 offer additional security for the jack 10 to maintain the vehicle 2 elevated off of the ground surface 6. The support bars 20 are manually or automatically positioned and restored along the housing 14.

FIG. 3 shows that the integral jack system includes, mounted on the underside 2a of the vehicle 2, a control system that includes a compressor or pneumatic pump 30 mounted on the underside 2a of the vehicle 2 for providing pneumatic fluid (compressed air) via pneumatic lines to each of the jacks 10. The air distribution system may include pneumatic valves that independently control distribution of compressed air from the pump 30 to the jacks 10, the valves being electronically controlled and activated from the control panel 40, described below. Additionally, a plurality of sensors is provided for determining certain vehicle conditions before executing the deployment of anyone of the jacks 10. Sensor 32 detects the operating condition of the engine. Sensor 32 cooperates with the control system to ensure that the engine is off, as a safety precaution, before elevating the vehicle 2 by the jacks 10. Sensor 34 detects the condition of the parking brake of the vehicle, ensuring that the parking brake is engaged before the execution of the vehicle 2 lifting by the jacks 10. A third sensor 36 detects the state of the vehicle transmission, ensuring that the transmission of the vehicle 2 is in the ‘PARK’ position (for automatic transmissions), and/or in ‘FIRST GEAR’ (for manual transmissions).

Optionally, a fourth sensor may be provided for detecting the location of the flat tire when the tire is flat or low on pressure. This type of flat tire sensor incorporate one of the following pressure detection mechanisms: measurement of the distance from the car floor to the ground (if the measurement is less than a predetermined value, the sensor will notify the control panel and activate the red light); a fluid level, similar to mercury in a thermostat, that operates as a switch to close a circuit to generate an alarm that the tire associated therewith is low on air pressure or flat; a mechanical limit switch that deactivates an electrical circuit connection (such as a spring-biased contact on the chassis that is connected to the wheel, tie rod arm, or the like by a wire that is pulled down to trip the contact when the tire goes flat or loses enough pressure that the car is no longer level); or a pressure gauge attached to the tire that sends pressure values to the main control panel to continuously compare the measured pressure with stored threshold pressure values, which may activate the red color light next to the FR, FL, RR, and RL indicia on the control panel when the measured pressure is less than the stored threshold value.

A fifth sensor may be provided to detect the integrity of the wheel bolts on the flat tire. This sensor monitors the torque of the wheel bolts, provides an indication of when the wheel bolts on the flat tire are loose enough to remove the tire prior to lifting the wheel from the ground.

This is a further safety precaution to ensure that the vehicle 2 is stable in order to execute lifting the vehicle 2 via the jacks 10. The system is powered by a power supply PS, generally denoted as the battery of the vehicle. In addition, a further safety provision of the system extends the other three jacks to touch the ground to stabilize the vehicle while the fourth jack performs the lifting operation on the actual flat tire.

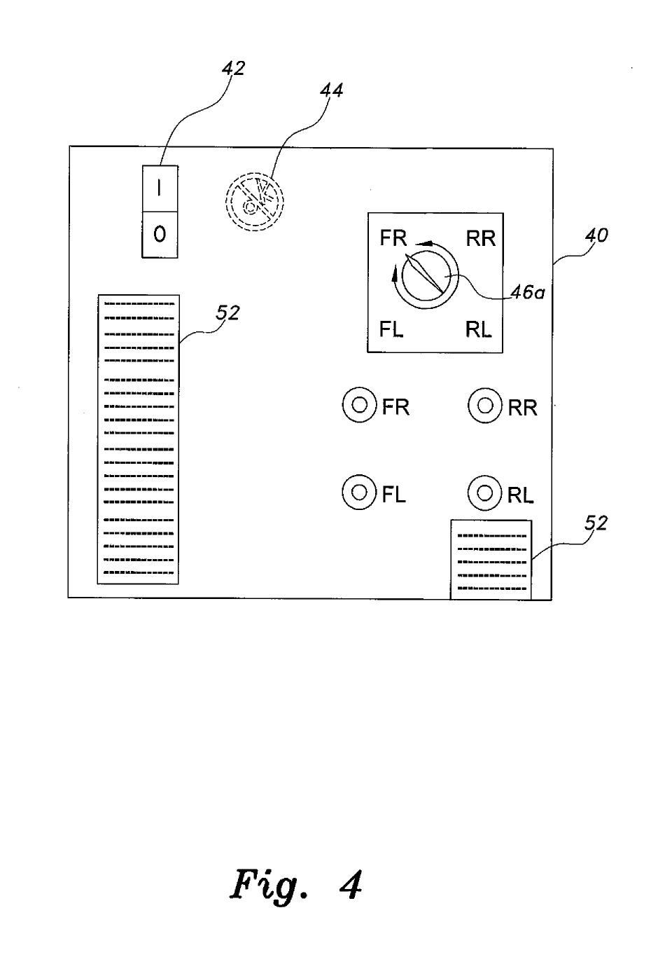

The control system has a control panel 40, as seen in FIG. 4. The control panel 40 is typically located in the trunk 4 of the vehicle 2 (see FIG. 1). The trunk 4 is accessed via the trunk lid 4a. The trunk 4 location of the control panel 40 is selected because it allows the user the opportunity to ensure all safety conditions are met, and it is conveniently located near access to the spare tire. The control panel 40 has a main ON/OFF switch 42 for actuating the control system and pneumatic pump 30. The control panel 40 also includes indicia 52 imprinted thereon (or attached by label) to provide the user with step-by-step instructions to safely use the pneumatic jacks 10. Upon activation, the sensors 32, 34, 36 report the specific sensed conditions, and an indicator lamp 44 (and/or audible annunciation) provides the user with a go ahead to use the system for lifting a wheel of vehicle 2 off the ground 6.

In use, when a flat tire is detected via the sensors, a visual indication is illuminated (or an audio indication is sounded), and the appropriate button adjacent to the FR, LR, RR and RL indicia is illuminated. For example, a visual indication of a flat front right tire would be a RED light next to the FR indicia, and, if not flat, then a GREEN light, and so on for each tire. This illumination is simultaneous for the four tires so that user will know which switch to actuate for fixing the flat tire, by selecting the appropriate tire position via the knob 46a. Once a flat tire sensor (e.g., distance sensor, fluid level sensor, or mechanical limit switch, a tire pressure gauge, as described above) sends an indication to the main control panel, activation of the FR, FL, RR, and RL visual indicators by the main control panel would indicate which tire needs to be changed. Upon activation, the remainder of the various vehicle condition sensors would be used to indicate whether it was safe for the vehicle to be lifted by the jack via indicator 44.

Once receiving the go ahead indication, the user turns the selector knob 46a to the preferred wheel position to be lifted. The control system and pneumatic pump produce enough pneumatic pressure to actuate all of the jacks 10, such that each one of the jacks extends and engages the ground surface 6. Upon completion of the task, the ON/OFF switch 42 deactivates the system, and all of the jacks 10 are returned to the retracted and closed positions, thus ensuring the safety of the user.

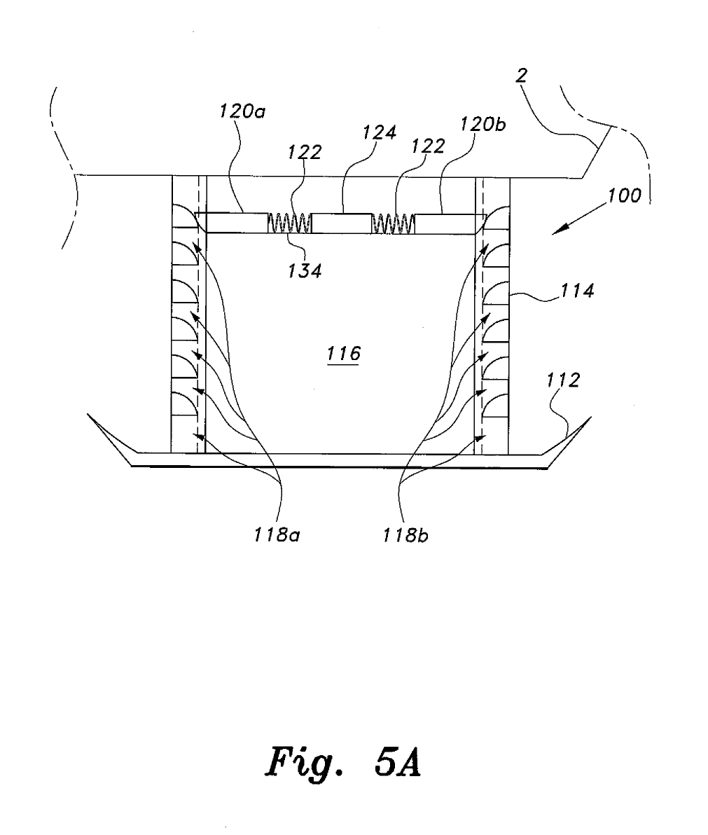

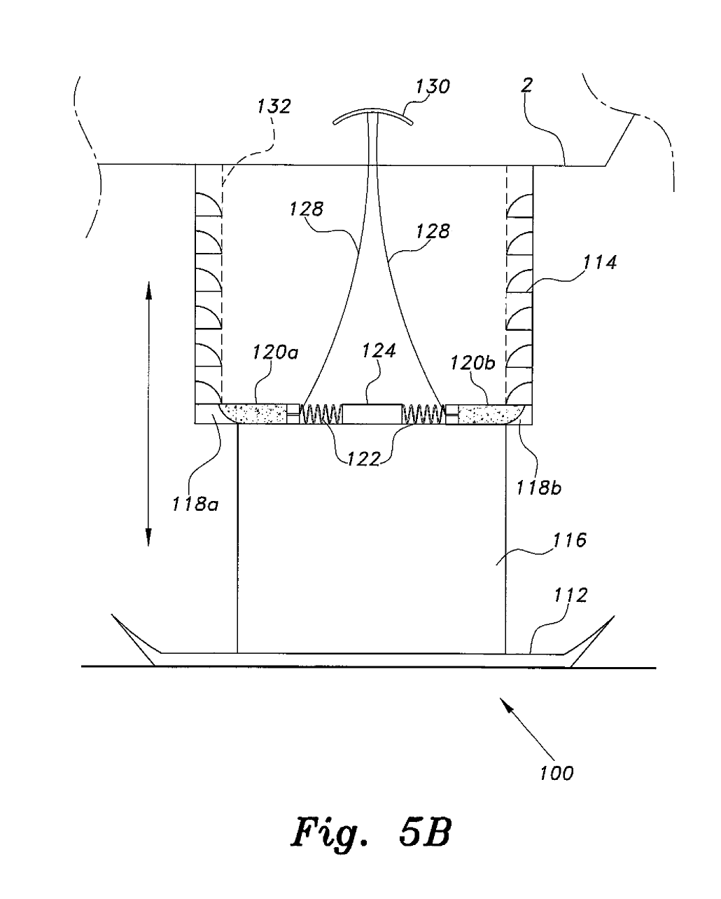

The alternative embodiment of FIGS. 5A and 5B is similar to that described above. The system includes at least one pneumatic jack 100 adapted for being integrally mounted beneath automobile 2 adjacent at least one wheel thereof. The at least one pneumatic jack 100 includes a housing 114 and a piston 116 extendable from the housing, as described above. The piston 116 has opposed upper and lower ends, as in the previous embodiment, and a foot 112 attached to the lower end thereof.

The housing has at least one first recess 118a and at least one second recess 118b defined in an inner surface 132 thereof. The at least one first recess 118a and the at least one second recess 118b are diametrically opposed with respect to one another. Preferably, the at least one first recess 118a and the at least one second recess 118b each comprise a vertically-extending linear array of recesses.

First and second stop members 120a, 120b are mounted to the upper end 134 of piston 116. Each of the first and second stop members 120a, 120b is spring-biased (essentially comprising spring-biased detent pins) and respectively alignable with the at least one first recess 118a and the at least one second recess 118b defined in the inner surface 132 of the housing 114. A central mount 124 may be secured to the upper surface 134 of the piston 116, such that respective springs 122 may be secured to, and extend between, the mount 124 and the first and second stop members 120a, 120b.

In FIG. 5A, the piston 116 is in a stored or retracted state with respect to the housing 114. In FIG. 5B, where the piston 116 is deployed (i.e., in the extended state with respect to the housing 114), each of the first and second stop members 120a, 120b resiliently and releasably engages the at least one first recess 118a and the at least one second recess 118b, respectively, to releasably maintain and securely hold the piston 116 in an extended state with respect to the housing 114.

In FIG. 5B, wires or lines 128 are shown respectively fixed to the first and second stop members 120a, 120b. The wires or lines 128, as shown, may be secured to a handle member 130. In use, in order to retract the stop members 120a, 120b such that the piston 116 may be raised to return the piston 116 to the retracted state of FIG. 5A, the user may manually pull the handle 130, or the wires 128 may be automatically driven and controlled by the control system through a suitable linkage. It should be understood that the overall configuration and relative dimensions of the stop members 120a, 120b and the corresponding recesses 118a, 118b are shown in FIGS. 5A and 5B for exemplary purposes only, and may be vary in particular embodiments.

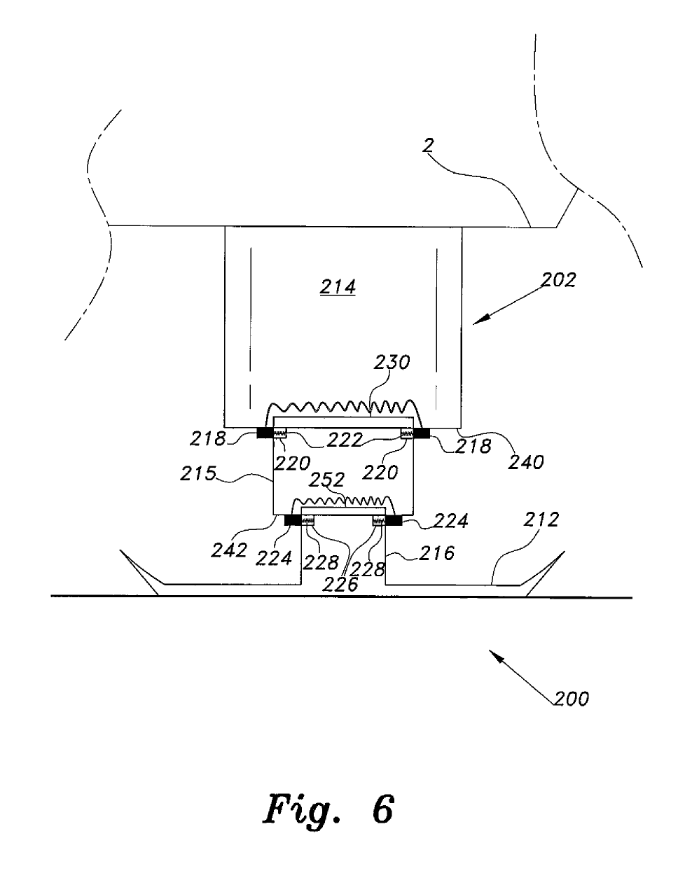

In the further alternative embodiment of FIG. 6, the system includes at least one pneumatic jack 200 adapted for being integrally mounted beneath an automobile 2 adjacent at least one wheel thereof. The at least one pneumatic jack 200 includes a housing 202 and a piston 216 extendable from the housing 202, as described above. The piston 216 has opposed upper and lower ends, as in the previous embodiments, and a foot 212 attached to the lower end thereof.

In the embodiment of FIG. 6, the housing 202 includes upper and lower portions 214, 215, respectively, telescopically joined to one another such that the lower portion 215 telescopes from the upper portion 214. A first set of spring-biased stop members 218 (essentially spring-biased detent pins) is mounted adjacent an upper end 230 of the lower portion 215 of the housing 202, such that when the lower portion 215 is an extended state with respect to the upper portion 214 of the housing 202, the first set of stop members 218 resiliently engage a lower annular wall 240 of the upper portion 214 to releasably maintain the lower portion 215 in the extended state with respect to the upper portion 214 of housing 202. Similarly, a second set of spring-biased stop members 224 is mounted adjacent the upper end 252 of the piston 216, such that when the piston 216 is in an extended state with respect to the lower portion 215 of housing 202, the second set of stop members 224 resiliently engage a lower annular wall 242 of the lower portion 215 to releasably maintain the piston 216 in the extended state with respect to the lower portion 215 of housing 202.

As shown in FIG. 6, a first set of recesses 222 is preferably defined in the lower portion 215 of the housing 202 adjacent the upper end 230 thereof for releasably receiving the first set of stop members 218 therein. The first set of stop members 218 is spring-biased within the first set of recesses 222 (when in the collapsed state) by expansion of compression springs 220. Similarly, a second set of recesses 226 is defined in the piston 216 adjacent the upper end 252 thereof for releasably receiving the second set of stop members 224 therein. The second set of stop members 224 is spring-biased within the second set of recesses 226 (when in the collapsed state) by expansion of compression springs 228. The first and second sets of stop members 218, 224, respectively, may be retracted by any suitable mechanism, such as a wired retraction system similar to that described above with respect to the embodiment of FIGS. 5A and 5B. Further, it should be understood that the overall configuration and relative dimensions of the stop members 218, 224 and the corresponding recesses 222, 226 are shown in FIG. 6 for exemplary purposes only, and may vary in particular embodiments.

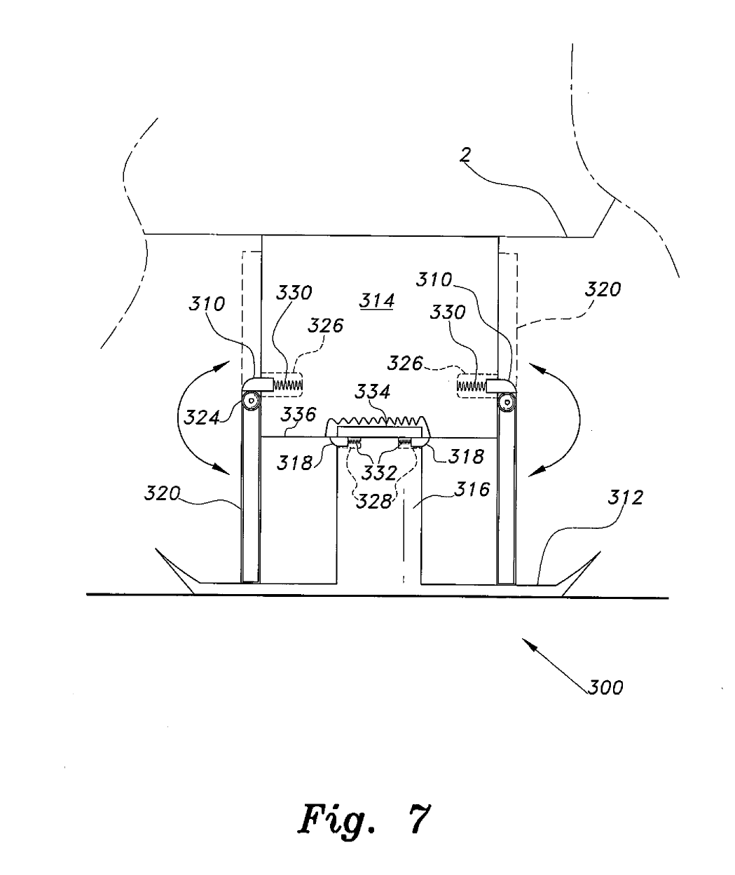

In the embodiment of FIG. 7, the system similarly includes at least one pneumatic jack 300 adapted for being integrally mounted beneath an automobile 2 adjacent at least one wheel thereof. The at least one pneumatic jack 300 includes a housing 314 and a piston 316 extendable from the housing 314, as described above. The piston 316 has opposed upper and lower ends, as in the previous embodiments, and a foot 312 attached to the lower end thereof

Similar to the embodiment of FIG. 2, the at least one pneumatic jack 300 includes at least one support bar 320 having opposed fixed and free ends. The fixed end is pivotally mounted to the housing 314 by a hinge pin 324 or the like. When the piston 316 extends from the housing 314, the at least one support bar 320 pivots to extend between the housing 314 and the foot 312, providing vertical support for the housing 314. In a manner similar to that of the embodiment of FIG. 6, at least one first spring biased stop member 310 (essentially a spring-biased detent pin) is mounted to the housing 314 adjacent the fixed end 324 of the at least one support bar 320, such that when the at least one support bar 320 extends between the housing 314 and the foot 312, the at least one first stop member 310 releasably prevents pivoting of the at least one support bar 320. Similarly, at least one second spring-biased stop member 318 is mounted adjacent the upper end 334 of the piston 316, such that when the piston 316 is in the extended state with respect to the housing 314, the at least one second stop member 318 resiliently engages a lower annular wall 336 of the housing 314 to releasably maintain the piston 316 in the extended state with respect thereto.

As shown in FIG. 7, at least one first recess 326 is preferably defined in the housing 314 adjacent the fixed end 324 of the support 320 for releasably receiving the at least one first stop member 310 therein. The at least one first stop member 310 is spring-biased within the at least one first recess 326 (when in the collapsed state) by at least one first spring 330. Similarly, at least one second recess 328 is preferably defined in the piston 316 adjacent the upper end 334 thereof for releasably receiving the at least one second stop member 318 therein. The at least one second stop member 318 is spring-biased within the at least one second recess 328 (when in the collapsed state) by at least one second spring 332. The first and second stop members 310, 318, respectively, may be retracted by any suitable mechanism, such as a wired retraction system similar to that described above with respect to the embodiment of FIGS. 5A and 5B, preferably under control of the control system. Further, it should be understood that the overall configuration and relative dimensions of first and second stop members 310, 318 and the corresponding recesses 326, 328 are shown in FIG. 7 for exemplary purposes only, and may vary in particular embodiments.

It is to be understood that the present invention is not limited to the embodiments described above, but encompasses any and all embodiments within the scope of the following claims.

We claim:

1. A pneumatic jack system adapted for mounting on an automobile, comprising:
at least one pneumatic jack adapted for being integrally mounted beneath an automobile adjacent at least one wheel thereof, the at least one pneumatic jack having a housing and a piston extendable from the housing, the piston having opposed upper and lower ends and a foot attached to the lower end thereof, the housing having at least one first recess and at least one second recess defined in an inner surface thereof, the at least one first recess and the at least one second recess being diametrically opposed with respect to one another;
a pneumatic pump adapted for mounting beneath the automobile for providing compressed air;
at least one hose line connected between the pneumatic pump and the at least one pneumatic jack;
a control system having means for controlling the pneumatic pump to provide pneumatic fluid to the at least one pneumatic jack via the at least one hose line, so that the piston of the at least one pneumatic jack is extendable from beneath the automobile upon receiving compressed air from the pneumatic pump for a distance sufficient to engage a ground surface and raise the at least one wheel adjacent the at least one pneumatic jack above the ground surface; and
first and second stop members mounted to the upper end of the piston, each of the first and second stop members being spring-biased and respectively alignable with the at least one first recess and the at least one second recess defined in the inner surface of the housing, so that when the piston is in an extended state, each of the first and second stop members resiliently and releasably engages the at least one first recess and the at least one second recess, respectively, to releasably maintain the piston in the extended state with respect to the housing.

2. The pneumatic jack system according to claim 1, wherein the at least one jack comprises a plurality of jacks adapted for associating one of the jacks with each wheel of the automobile, and wherein the at least one hose line includes one hose line coupled between each one of the plurality of jacks and the pump.

3. The pneumatic jack system according to claim 2, wherein the at least one jack comprises four jacks, each one of the four jacks being adapted for mounting adjacent a corresponding wheel of the automobile.

4. The pneumatic jack system according to claim 1, wherein said control system further comprises a plurality of condition sensors for determining safety criteria upon actuation of the system.

5. The pneumatic jack system according to claim 4, wherein the condition sensors comprise sensors for sensing engine, transmission, and brake actuations.

6. The pneumatic jack system according to claim 5, wherein said control system comprises a control panel having indicators coupled to said condition sensors for displaying an indication of conditions sensed by said condition sensors.

7. The pneumatic jack system according to claim 6, wherein said control panel has means for activating the system and means for providing an indication that the automobile is safe to be lifted, said control panel further including instruction indicia printed thereon.

8. The pneumatic jack system according to claim 1, wherein the at least one first recess comprises a vertically-extending linear array of first recesses, and the at least one second recess comprises a vertically-extending linear array of second recesses.

9. The pneumatic jack system according to claim 1, further comprising:
a mount secured to the upper end of the piston; and
first and second springs, the first and second springs being secured to and extending between the mount and a respective one of said stop members.

10. The pneumatic jack system according to claim 9, further comprising:
first and second wires having opposed upper and lower ends, the lower ends being respectively secured to the first and second stop members; and
a handle, the upper ends of the first and second wires being respectively secured to the handle.

11. A pneumatic jack system adapted for mounting on an automobile, comprising:
at least one pneumatic jack adapted for being integrally mounted beneath an automobile adjacent at least one wheel thereof, the at least one pneumatic jack having a housing and a piston extendable from the housing, the piston having opposed upper and lower ends and a foot attached to the lower end, the housing having upper and lower portions telescopically joined to one another with the lower portion telescoping from the upper portion;
a pneumatic pump adapted for mounting beneath the automobile for providing compressed air;
at least one hose line connected between the pneumatic pump and the at least one pneumatic jack;
a control system having means for controlling the pneumatic pump to provide pneumatic fluid to the at least one pneumatic jack via the at least one hose line, the piston of the at least one pneumatic jack being extendable from beneath the automobile upon receiving compressed air from the pneumatic pump for a distance sufficient to engage a ground surface and raise the at least one wheel adjacent the at least one pneumatic jack above the ground surface;
a first set of spring-biased stop members mounted adjacent an upper end of the lower portion of the housing, so that when the lower portion is an extended state with respect to the upper portion of the housing, the first set of stop members resiliently engages a lower annular wall of the upper portion to releasably maintain the lower portion in the extended state with respect to the upper portion of the housing; and
a second set of spring-biased stop members mounted adjacent the upper end of the piston, so that when the piston is in an extended state with respect to the lower portion of the housing, the second set of stop members resiliently engages a lower annular wall of the lower portion to releasably maintain the piston in the extended state with respect to the lower portion of the housing.

12. The pneumatic jack system according to claim 11, wherein the at least one jack comprises a plurality of jacks adapted for associating one of the jacks with each wheel of the automobile, and wherein the at least one hose line includes one hose line coupled between each one of the plurality of jacks and the pump.

13. The pneumatic jack system according to claim 11, wherein said control system further comprises a plurality of condition sensors for determining safety criteria upon actuation of the system.

14. The pneumatic jack system according to claim 13, wherein said condition sensors comprise sensors for sensing engine, transmission, and brake actuations.

15. The pneumatic jack system according to claim 14, wherein said control system comprises a control panel having indicators coupled to said condition sensors for displaying an indication of conditions sensed by said condition sensors.

16. The pneumatic jack system according to claim 15, wherein said control panel has means for activating the system and means for providing an indication that the automobile is safe to be lifted, said control panel further including instruction indicia printed thereon.

17. The pneumatic jack system according to claim 11, wherein a first set of recesses is defined in the lower portion of the housing adjacent the upper end thereof for releasably receiving the first set of stop members therein, and a second set of recesses is defined in the piston adjacent the upper end thereof for releasably receiving the second set of stop members therein.

18. A pneumatic jack system adapted for mounting on an automobile, comprising:
at least one pneumatic jack adapted for being integrally mounted beneath an automobile adjacent at least one wheel thereof, the at least one pneumatic jack having a housing and a piston extendable from the housing, the piston having opposed upper and lower ends and a foot attached to the lower end thereof;
at least one support bar having opposed fixed and free ends, the fixed end being pivotally mounted to the housing of the at least one pneumatic jack, so that when the piston extends from the housing, the at least one support bar pivots to extend between the housing and the foot, providing vertical support for the housing;
a pneumatic pump adapted for mounting beneath the automobile for providing compressed air;
at least one hose line connected between the pneumatic pump and the at least one pneumatic jack;
a control system having means for controlling the pneumatic pump to provide pneumatic fluid to the at least one pneumatic jack via the at least one hose line, the piston of the at least one pneumatic jack being extendable from beneath the automobile upon receiving compressed air from the pneumatic pump for a distance sufficient to engage the ground and raise the wheel adjacent the jack above the ground;
at least one first spring-biased stop member mounted to the housing adjacent the fixed end of the at least one support bar, so that when the at least one support bar extends between the housing and the foot, the at least one first stop member releasably prevents pivoting of the at least one support bar; and
at least one second spring-biased stop member mounted adjacent the upper end of the piston, so that when the piston is in an extended state with respect to the housing, the at least one second stop member resiliently engages a lower annular wall of the housing to releasably maintain the piston in the extended state with respect thereto.

19. The pneumatic jack system according to claim 18, wherein at least one first recess is defined in the housing adjacent the fixed end of the at least one support bar for releasably receiving the at least one first stop member therein, and at least one second recess is defined in the piston adjacent the upper end thereof for releasably receiving the at least one second stop member therein.

20. The pneumatic jack system according to claim 18, wherein said control system further comprises a plurality of condition sensors for determining safety criteria upon actuation of the system.
